(19) United States
(12) Patent Application Publication
(10) Pub. No.: US 2004/0081367 A1
(43) Pub. Date: Apr. 29, 2004

(54) Image data correction apparatus and method

(76) Inventor: Shunichiro Nonaka, Asaka-shi (JP)

Correspondence Address: BIRCH STEWART KOLASCH & BIRCH, PO BOX 747, FALLS CHURCH, VA, 22040-0747, US

(21) Appl. No.: 10/685,404

(22) Filed: Oct. 16, 2003

(30) Foreign Application Priority Data
Oct. 18, 2002 (JP) 2002-303800

(51) Int. Cl. G06K 9/40

(52) U.S. Cl. 382/263; 382/261

(57) ABSTRACT

Gain coefficients g1 to g4 of image data to undergo a sharpness correction and a high-frequency component F of the overall image are calculated. The gain coefficients g1 to g4 are decreased in value the larger the high-frequency component F of the overall image and increased in value the smaller the high-frequency component F of the overall image. In a situation where the high-frequency component F of the overall image is large and it is feared that noise will be emphasized by applying a sharpness correction, the gain coefficients for the sharpness correction are reduced. This assures that noise will not be emphasized even if the sharpness correction is applied.

### BACKGROUND OF THE INVENTION

1. Field of the Invention

This invention relates to an apparatus and method for correcting image data.

2. Description of the Related Art

Sharpness correction is available as a method of improving the sharpness of an image. In general, sharpness is corrected as follows: First, one frame of an image is divided into a plurality of areas. For each area of the plurality of areas into which the image has been divided, a high-frequency component of the image data representing the image within each area is calculated. Gain coefficients in respective ones of the areas are calculated in accordance with the proportion of the calculated high-frequency components. The calculated coefficients are used to multiply the image data representing the image within the corresponding areas.

If image data that is to undergo the sharpness correction contains noise, there are instances where the noise is emphasized by the sharpness correction.

A technique for changing the gain coefficients of a sharpness correction using the parameter of a grayscale correction is available as means for improving the sharpness correction (e.g., see the specification of Japanese Patent Application Laid-Open No. 2000-115534). However, the technique described in this reference does not take into consideration emphasis of noise by the sharpness correction.

### DISCLOSURE OF THE INVENTION

Accordingly, an object of the present invention is to prevent noise from being emphasized.

According to the present invention, the foregoing object is attained by providing an image data correction apparatus comprising: a first high-frequency component calculation device (first high-frequency component calculation means) for calculating, for each area obtained when one frame of an image has been divided into a plurality of areas, a high-frequency component of original image data representing one frame of the image; a gain coefficient calculation device (gain coefficient calculation means) for calculating gain coefficients of a sharpness correction based upon the high-frequency components of respective ones of the areas calculated by the first high-frequency component calculation device; a second high-frequency component calculation device (second high-frequency component calculation means) for calculating a high-frequency component of the original image data; a gain coefficient correction device (gain coefficient correction means) for correcting the gain coefficients, which have been calculated by the gain coefficient calculation device, based upon the proportion of the high-frequency component, which has been calculated by the second high-frequency component calculation device, in the one frame of the image; and a sharpness correction device (sharpness correction means) for using the gain coefficients, which have been calculated by the gain coefficient correction device, to apply a sharpness correction to image data representing corresponding ones of the areas in the original image

The present invention also provides a method suited to the image data correction apparatus described above. Specifically, the method comprises the steps of calculating proportion of a high-frequency component of original image data, which represents one frame of an image, for each area obtained when one frame of the image has been divided into a plurality of areas; calculating gain coefficients of a sharpness correction based upon the calculated high-frequency components of respective ones of the areas; calculating a high-frequency component of the original image data; correcting the calculated gain coefficients based upon the calculated high-frequency component with respect to the one frame of the image; and using the calculated gain coefficients to apply a sharpness correction to image data representing corresponding ones of the areas in the original image data.

In accordance with the present invention, a high-frequency component of original image data representing one frame of an image is calculated for each area obtained when one frame of the image has been divided into a plurality of areas. On the basis of the high-frequency component calculated for each area, a sharpness-correction gain coefficient in each area is calculated. Further, the proportion of the high-frequency component with respect to the one frame of the image of the original image data is calculated. The calculated gain coefficients are corrected based upon the calculated high-frequency component in the one frame of the image.

Since the gain coefficients can be corrected, the extent of sharpness correction can be changed in dependence upon the state of noise contained in the image. For example, the extent of the sharpness correction can be increased if an image is one having little noise and can be decreased if an image is one having a great deal of noise.

For example, the gain coefficient correction device corrects the gain coefficients, which have been calculated by the gain coefficient calculation device, in such a manner that the greater the proportion of the high-frequency component with respect to the one frame of the image calculated by the second high-frequency component calculation device, the smaller the gain coefficients.

If there are many high-frequency components with respect to one frame of an image, it is considered that the image has a high degree of sharpness. Accordingly, the calculated gain coefficients are corrected in such a manner that the extent of the sharpness correction will be suppressed. By suppressing the extent of the sharpness correction, any noise in an image can be prevented from being emphasized. If there are few high-frequency components with respect to one frame of an image, on the other hand, it is considered that the image has a low degree of sharpness. Accordingly, the calculated gain coefficients are corrected in such a manner that the extent of the sharpness correction will be increased. Since the extent of the sharpness correction is increased, an image having a high degree of sharpness is obtained. Further, since it is considered that little noise is present, the noise can be prevented from becoming conspicuous owing to emphasis thereof even if the degree of sharpness correction is increased.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of a sharpness correction apparatus;

FIG. 2 illustrates the relationship between areas obtained by dividing up an image and high-frequency components;

FIG. 3 illustrates the relationship between areas obtained by dividing up an image and gain coefficients;

FIG. 4 illustrates correction of gain coefficients; and

FIG. 5 is a flowchart illustrating processing for sharpness correction.

### DESCRIPTION OF THE PREFERRED EMBODIMENT

A preferred embodiment of the present invention will now be described in detail with reference to the accompanying drawings.

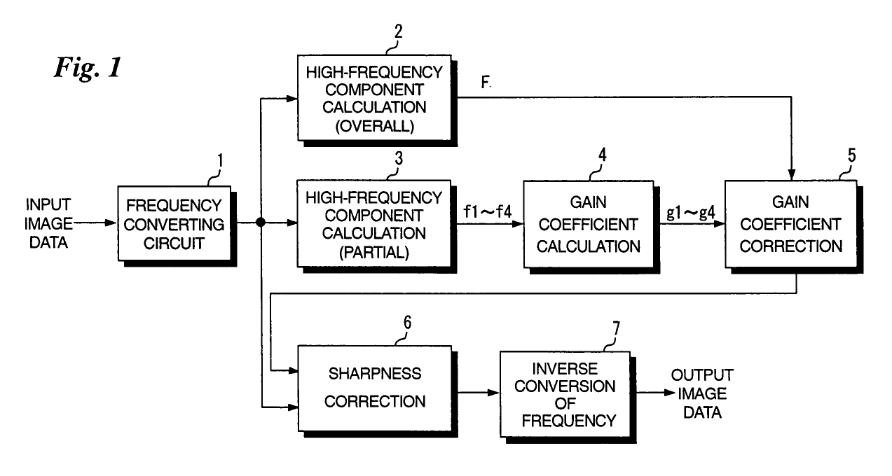

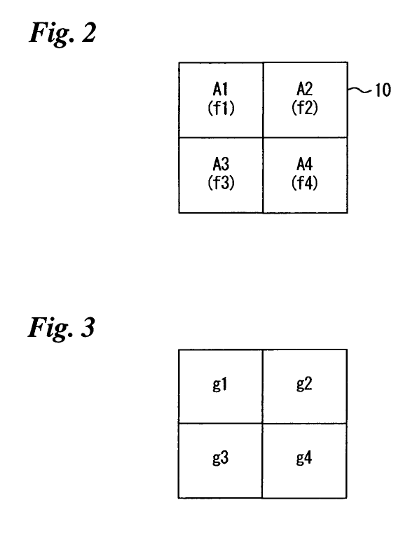

FIG. 1, which illustrates a preferred embodiment of the present invention, is a block diagram showing the electrical structure of a sharpness correction apparatus, FIG. 2 illustrates areas obtained by dividing up and image, and FIG. 3 illustrates gain coefficients obtained in association with the areas obtained by dividing up the image.

The sharpness correction apparatus according to this embodiment corrects gain coefficients, which are for a sharpness correction, in accordance with the high-frequency components of an overall image represented by entered image data.

Image data to undergo a sharpness correction (input image data representing one frame of an image) is input to a frequency converting circuit 1, which applies a frequency conversion such as a Fourier transform. The image data that has undergone the frequency conversion is input to a first high-frequency component calculating circuit 2, a second high-frequency component calculating circuit 3 and a sharpness correcting circuit 6.

The first high-frequency component calculating circuit 2 calculates a high-frequency component F in the entirety of the one frame of the image represented by the input image data. Data representing the overall high-frequency component F calculated is input to a gain coefficient correcting circuit 5.

As shown in FIG. 2, the second high-frequency component calculating circuit 3 calculates high-frequency components f1, f2, f3 and f4 in respective ones of areas A1, A2, A3 and A4 when one frame of an image 10 represented by the input image data has been divided into these four areas A1, A2, A3 and A4. The data representing the calculated high-frequency components f1, f2, f3 and f4 is input to a gain coefficient calculating circuit 4. The latter obtains gain coefficients g1, g2, g3 and g4 in association with the areas A1, A2, A3 and A4, respectively, based upon the entered high-frequency components f1, f2, f3 and f4. Data representing the gain coefficients g1, g2, g3 and g4 is input to the gain coefficient correcting circuit 5.

The gain coefficient correcting circuit 5 corrects the gain coefficients that have been calculated in the gain coefficient calculating circuit 4.

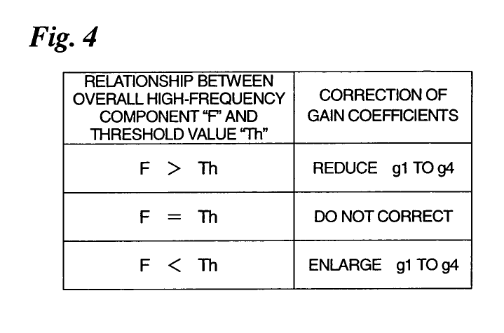

FIG. 4 illustrates the details of the correction performed by the gain coefficient correcting circuit 5.

If the high-frequency component F calculated in the first high-frequency component calculating circuit 2 is greater than a predetermined threshold value Th, then the gain coefficients g1, g2, g3 and g4 that have been calculated are diminished. In this case, it is considered that the image represented by the input image data has a high degree of sharpness and, hence, there is no need to increase sharpness further. In addition, since noise is enhanced by performing a sharpness correction, the calculated gain coefficients g1, g2, g3 and g4 are diminished so as to suppress the sharpness correction.

If the high-frequency component F calculated in the first high-frequency component calculating circuit 2 is less than the predetermined threshold value Th, then the calculated gain coefficients g1, g2, g3 and g4 are increased in value. In this case, it is considered that the input image data contains little noise. This means that noise will not become conspicuous even though a sharpness correction is applied.

If the high-frequency component F calculated in the first high-frequency component calculating circuit 2 is equal to the predetermined threshold value Th, then the calculated gain coefficients g1, g2, g3 and g4 are not corrected.

Data representing the gain coefficients corrected in the gain coefficient correcting circuit 5 is input to the sharpness correcting circuit 6. As mentioned above, the image data that has been output from the frequency converting circuit 1 is input to the sharpness correcting circuit 6 as well. The sharpness correcting circuit 6 applies a sharpness correction by multiplying the image data representing the images of each of the areas A1, A2, A3 and A4 by the corresponding gain coefficients from among the corrected gain coefficients g1, g2, g3 and g4. The output of the sharpness correcting circuit 6 is subjected to an inverse frequency conversion in an inverse-conversion unit 7, which delivers the output image data.

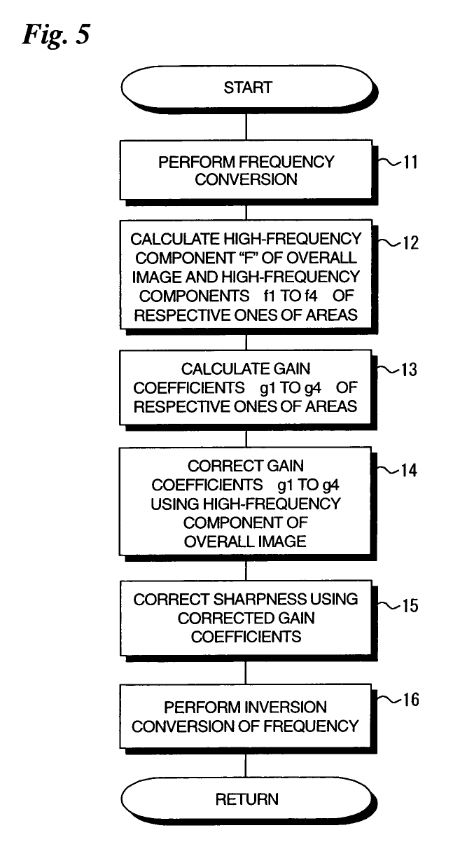

FIG. 5 is a flowchart illustrating processing for correcting sharpness.

First, the input image data is subjected to a frequency conversion (step 11). Next, the high-frequency component of the overall image represented by the input image data is calculated, as well as high-frequency components f1 to f4 of images in respective ones of the areas obtained by dividing the overall image into a plurality of areas (step 12). The gain coefficients g1 to g4 for respective ones of the areas are then calculated (step 13).

The calculated gain coefficients g1 to g4 are corrected using the high-frequency component F of the overall image (step 14), then a sharpness correction is applied to the image data using the corrected gain coefficients (step 15). The image data that has undergone the sharpness correction is subjected to an inverse frequency conversion (step 16).

Though the process steps mentioned above are implemented by hardware in the above embodiment, it may be so arranged that they are implemented by software.

As many apparently widely different embodiments of the present invention can be made without departing from the spirit and scope thereof, it is to be understood that the invention is not limited to the specific embodiments thereof except as defined in the appended claims.

What is claimed is:

1. An image data correction apparatus comprising:
a first high-frequency component calculation device for calculating, for each area obtained when one frame of an image has been divided into a plurality of areas, a high-frequency component of original image data representing one frame of the image;
a gain coefficient calculation device for calculating gain coefficients of a sharpness correction based upon the high-frequency components of respective ones of the areas calculated by the first high-frequency component calculation device;
a second high-frequency component calculation device for calculating a high-frequency component of the original image data;
a gain coefficient correction device for correcting the gain coefficients, which have been calculated by said gain coefficient calculation device, based upon the high-frequency component, which has been calculated by said second high-frequency component calculation device, with respect to the one frame of the image; and
a sharpness correction device for using the gain coefficients, which have been calculated by said gain coefficient correction device, to apply a sharpness correction to image data representing corresponding ones of the areas in the original image data.

2. The apparatus according to claim 1, wherein said gain coefficient correction device corrects the gain coefficients, which have been calculated by said gain coefficient calculation device, in such a manner that the greater the high-frequency component regarding the one frame of the image calculated by said second high-frequency component calculation device, the smaller the gain coefficients.

3. A method of correcting image data, comprising the steps of:
calculating a high-frequency component of original image data, which represents one frame of an image, for each area obtained when one frame of the image has been divided into a plurality of areas;
calculating gain coefficients of a sharpness correction based upon the calculated high-frequency components of respective ones of the areas;
calculating a high-frequency component of the original image data;
correcting the calculated gain coefficients based upon the calculated high-frequency component with respect to the one frame of the image; and
using the calculated gain coefficients to apply a sharpness correction to image data representing corresponding ones of the areas in the original image data.
